(19) United States
(12) Patent Application Publication
(10) Pub. No.: US 2016/0148442 A1
(43) Pub. Date: May 26, 2016

(54) module and system for vehicle diagnosis

(71) Applicant: ROBERT BOSCH GMBH, Stuttgart (DE)

(72) Inventor: Eberhard KUEMMEL, Allmersbach (DE)

(21) Appl. No.: 14/899,266

(22) PCT Filed: Apr. 30, 2014
(86) PCT No.: PCT/EP2014/058918

§ 371 Date: Dec. 17, 2015

(30) Foreign Application Priority Data
Jun. 19, 2013 (DE) 10 2013 211 515.6

(51) Int. Cl. G07C 5/00; G07C 5/08; G07C 5/02

(52) U.S. Cl. CPC G07C 5/008; G07C 5/02; G07C 5/08

(57) ABSTRACT

A diagnostic module for vehicle diagnosis includes: a communication unit that is embodied for data transfer with a control unit of a motor vehicle; a diagnostic unit that is embodied to perform a diagnosis of the motor vehicle on the basis of the diagnostic data transferred by the communication unit; and a transmitting unit that is embodied to transfer diagnostic data from the diagnostic module to a server. The transmitting unit is embodied to transfer the diagnostic data from the diagnostic module to the server via a mobile radio network and/or the internet.

### BACKGROUND OF THE INVENTION

1. Field of the Invention

The invention relates to a module usable in mobile fashion, and a system, for vehicle diagnosis, in particular for motor vehicle diagnosis, which uses a wireless data transfer system.

2. Description of the Related Art

In motor vehicle service facilities it is known to read out and analyze data from a control unit of the motor vehicle in order to identify faults in and/or wear on components of the motor vehicle, for example the engine, in particular the injection system, the climate control system, the navigation system, the exhaust emissions control system, etc.

This requires a visit with the motor vehicle to a service facility that carries out the diagnosis. The service facility visit, for which an appointment as a rule must be made, is laborious and inconvenient for the motor vehicle owner.

### BRIEF SUMMARY OF THE INVENTION

An object of the invention is therefore to simplify motor vehicle diagnosis and make it more convenient in particular for the owner of the motor vehicle.

A diagnostic module according to the present invention is capable of reading out, from at least one control unit of a motor vehicle, diagnostic data that relate, for example, to the engine, in particular the injection system, climate control system, navigation system, and/or exhaust emissions control system; analyzing them; and transferring analytical results wirelessly to a server, in particular via a mobile radio network and/or the internet.

A diagnostic module according to the present invention encompasses for that purpose, in particular: a communication unit that is embodied to read out diagnostic data of the control unit of the motor vehicle; a diagnostic unit that is embodied to analyze diagnostic data read out by the communication unit in order to carry out a diagnosis of the motor vehicle; and a transmitting unit that is embodied to transfer data, which in particular encompass diagnostic data transferred by the communication unit and/or analysis results, from the communication module to a server, in particular via a mobile radio network and/or the internet.

A system according to the present invention for motor vehicle diagnosis encompasses at least one diagnostic module according to the present invention and moreover a server that is embodied to receive diagnostic data from the at least one diagnostic module, in particular via a mobile radio network and/or the internet, and make them available to at least one user. The service is can be embodied in particular to anonymize the diagnostic data before they are made available to the at least one user.

Transfer of the diagnostic data via the mobile radio network and/or the internet can be accomplished in encoded fashion in order to prevent unauthorized access to the data and/or spying on the data on the transmission route.

With a system according to the present invention for motor vehicle diagnosis, a motor vehicle owner can independently carry out a vehicle diagnosis at any point in time by establishing, at any point in time desired by him or her, a data connection between the communication unit of the diagnostic module and the control unit of the motor vehicle. The diagnostic module can be embodied for this purpose, for example, with a suitable plug connector that can be inserted into a corresponding socket, in particular an onboard diagnostic (OBD) socket, of the motor vehicle.

Alternatively or additionally, the communication unit can be embodied to communicate wirelessly, e.g. via a WLAN or Bluetooth® connection, with the control unit of the motor vehicle in order to exchange diagnostic data. A wireless data transfer between the motor vehicle and the communication unit is particularly convenient for the motor vehicle owner since he or she does not need to search, for example in the footwell or engine compartment of the motor vehicle, for a suitable socket that may be difficult to access and/or possibly dirty, in order to establish the data connection between the diagnostic module and the control unit of the motor vehicle.

In an embodiment, the diagnostic module additionally has a diagnostic module receiving unit that is embodied to receive data from the server, in particular via a mobile radio network and/or the internet. The reception of data from a suitably embodied server, which in particular has a correspondingly suitable transmitting apparatus or is connected to such a transmitting apparatus, allows the diagnostic module to be remotely controlled by the server.

Once the diagnostic module has ascertained the exact model of the motor vehicle, for example by reading out a model of the motor vehicle, and/or a vehicle identification number (VIN) uniquely associated with the motor vehicle, from the control unit of the motor vehicle, and has transferred it to a suitably embodied server, the server can select a suitable diagnostic software program specially adapted to the respective motor vehicle and transfer it via the wireless data connection to the diagnostic module. The motor vehicle diagnosis can in this manner always be carried out by the diagnostic module using a current diagnostic software program that is optimally adapted to the specific respective vehicle model.

In an embodiment, the server additionally has a user data receiving apparatus that is embodied in particular for the reception of SMS messages and/or e-mail messages. The server is then preferably embodied so that it displays, together with the diagnostic data received from the diagnostic module, the user data received by the user data receiving apparatus. The motor vehicle owner can in this manner, by sending an SMS message or e-mail message to the server, transfer additional information, for example his or her name and/or contact data including his or her telephone number, to the server.

The contact data transferred in this manner can then be displayed together with the diagnostic data in order to enable a service facility, which would like to accept the repair job found to be necessary based on the diagnostic data, to make contact with the motor vehicle owner. Display of the additional user data can be linked to the fact that the motor vehicle owner releases the data by giving his or her consent to display of the data, so that the data can be displayed only after a corresponding release by the motor vehicle owner. In an embodiment, the motor vehicle owner can furthermore also stipulate that the data be displayed only to members of a selected user group that has authenticated itself to the server, for example, by entering a password, a key card, or the like.

In an embodiment, the diagnostic module is additionally equipped with a location determination module, for example a GPS module, that allows the current position of the motor vehicle to be determined and the current position data for the motor vehicle to be transferred to the server via the transmitting apparatus, so that the server can display the current position of the motor vehicle together with the diagnostic data pertinent to the motor vehicle.

Alternatively or additionally, the server can be embodied to display, on the basis of the transferred position data and the known vehicle model, suitable service facilities that preferably are located in the vicinity of the current position of the motor vehicle, and/or optionally to contact them if desired by the motor vehicle owner in order to inquire whether they can accept the current repair job. Suitable service facilities in the vicinity of the current vehicle position can thereby be identified particularly easily, and contacted in a manner convenient for the vehicle owner.

The diagnostic module according to the present invention can in particular have small dimensions and preferably is no larger than a commercially usual pack of cigarettes. The diagnostic module can be purchased or rented, for example, in a commercial establishment, e.g. a filling station, car dealership, service facility, and/or shopping center, in order to carry out a motor vehicle diagnosis.

### BRIEF DESCRIPTION OF THE DRAWINGS

FIG. 1 is a schematic view of an exemplifying embodiment of a diagnostic system according to the present invention, with a motor vehicle.

FIG. 2 is a schematic enlarged view of a diagnostic module according to the present invention of a diagnostic system as shown in FIG. 1.

### DETAILED DESCRIPTION OF THE INVENTION

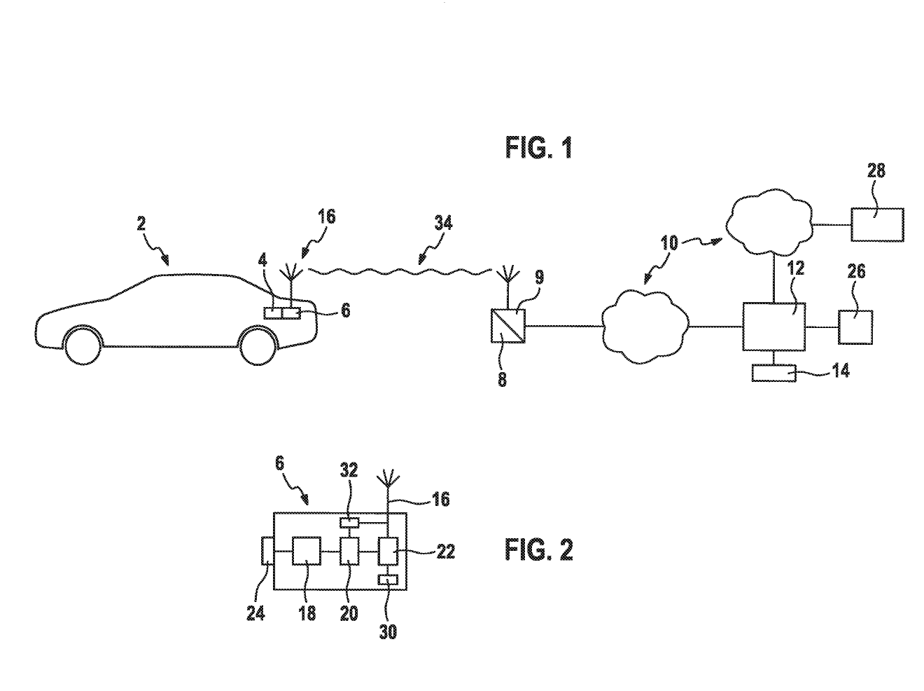

FIG. 1 schematically shows a motor vehicle 2 having a control unit 4 to which a diagnostic module 6 according to the present invention is connected via a plug connection (not visible in FIG. 1).

Diagnostic module 6 is embodied to read out diagnostic data from control unit 4 of motor vehicle 2 via a plug connection (not shown in FIG. 1) and transfer them wirelessly via an antenna 16 (depicted schematically in FIG. 1) to an associated receiving station 8.

Antenna 16 is shown in FIG. 1 outside motor vehicle 2 only for reasons of better elucidation. Antenna 16 can also, unlike what is shown in FIG. 1, be arranged entirely inside motor vehicle 2 and/or inside diagnostic module 6.

From receiving station 8, the received diagnostic data are transferred to a suitable server 12, for example, via the internet, e.g. utilizing a “cloud” service. Server 12 is embodied optionally to anonymize the received diagnostic data and to display at least some of the received diagnostic data on a suitable display apparatus 26.

Display apparatus 26 can be disposed, for example in the form of a monitor, directly on or in server 12. Further display apparatuses 28 can additionally or alternatively be provided, these being installed at a greater physical distance, for example in service facilities connected to the diagnostic system, and being connected to server 12 likewise via internet 10, in particular a cloud service.

Server 12 additionally also has a receiving apparatus 14 that is embodied to receive SMS messages and/or e-mail messages that can have been sent in particular by the motor vehicle owner. A telephone number and/or e-mail address, to which the SMS message or e-mail message is respectively to be sent so that it can be received by server 12, can be imprinted for this purpose on diagnostic module 6 or on the accessories, e.g. the operating instructions and/or packaging, of diagnostic module 6.

Server 12 is embodied to display on at least one of display apparatuses 26, 28 the data additionally transferred via SMS or e-mail, optionally after release by the motor vehicle owner, together with the diagnostic data of motor vehicle 2 that have been transferred by diagnostic module 6. Service facilities that are interested in accepting a repair job resulting from the vehicle diagnosis can thereby make contact with the motor vehicle owner with the aid of the data transferred by the motor vehicle owner via SMS or e-mail, for example in order to make a service facility appointment and/or to arrange to pick up motor vehicle 2.

FIG. 2 is an enlarged schematic view of an exemplifying embodiment of a diagnostic module 6 according to the present invention.

The exemplifying embodiment shown in FIG. 2 of diagnostic module 6 has, on its left side as depicted in FIG. 2, a suitable plug connector 24 that enables insertion of diagnostic module 6 into a suitable socket that is electrically connected to a control unit 4 of motor vehicle 2 in order to establish a data connection between control unit 4 and diagnostic module 6. The socket can be, in particular, a so-called “onboard diagnostic” (OBD) socket.

Diagnostic module 6 also has a communication unit 18 that is embodied to read out from control unit 4 of motor vehicle 2, via the data connection established with plug connector 24, diagnostic data that are necessary for a motor vehicle diagnosis, and to transfer them to a diagnostic unit 20 that is likewise provided in diagnostic module 6.

Diagnostic unit 20, which in particular can encompass a microprocessor, is embodied to perform a diagnosis of motor vehicle 2 on the basis of the diagnostic data transferred by communication unit 18. In a first step, diagnostic unit 20 can read out from control unit 4 the model and/or vehicle identification number (VIN) of motor vehicle 2 currently being investigated, and is embodied to transfer those data to server 12 via a transmitting unit 22 that is embodied in diagnostic module 6, antenna 16, wireless data connection 34 that can be established in particular via a mobile radio network, receiving station 8, and internet 10.

Server 12 thereupon identifies an optimally suitable diagnostic software program for motor vehicle 2 currently being examined, and transfers it via internet 10, a transmitting apparatus 9, and wireless data connection 34 to diagnostic unit 20, which receives the transferred diagnostic software using a suitable diagnostic module receiving unit 32 and installs it in diagnostic unit 20.

Transmitting apparatus 9 can be embodied integrally with or separately from receiving station 8.

Utilizing the diagnostic data read out by the communication unit from control unit 4 of motor vehicle 2, diagnostic unit 20 then carries out a diagnosis of motor vehicle 2 using the current diagnostic software that is optimally matched to the particular vehicle model to be examined and has been transferred as described above from server 12 to diagnostic module 6, and transmits the diagnostic results, with the aid of transmitting unit 22 and antenna 16, to receiving station 8, which transfers the diagnostic results to server 12 via internet 10, in particular a cloud service.

The diagnostic results can be displayed on at least one of display apparatuses 26, 28, in particular if a fault and/or maintenance requirement of motor vehicle 2 has been identified upon diagnosis of motor vehicle 2.

In order to ensure the anonymity of the motor vehicle owner, the diagnostic results can be anonymized before they are displayed so that no conclusions as to the identity of the motor vehicle owner and/or of motor vehicle 2 can be drawn from the displayed data. The anonymization can be canceled by the motor vehicle owner as necessary in order to enable a service facility to make contact with the motor vehicle owner, for example in order to arrange a service facility appointment.

Diagnostic module 6 shown in FIG. 2 is additionally equipped with a location identification module 30, in particular a GPS module, that allows current position data for motor vehicle 2 to be determined and allows the current position of motor vehicle 2 to be transferred via transmitting apparatus 22 to server 12 so that server 12 can display the current position of motor vehicle 2 together with the pertinent diagnostic data. It is particularly simple in this fashion to localize motor vehicle 2 in order to ascertain the closest service facility and/or to provide assistance in the event of a breakdown.

In order to prevent undesired monitoring of the motor vehicle owner, diagnostic module 6 and/or server 12 can be embodied in such a way that they identify and/or display the current position of motor vehicle 2 only when this function has been authorized by the motor vehicle owner, for example after a breakdown.

1-12. (canceled)

13. A diagnostic module for vehicle diagnosis, comprising:
a) a communication unit configured for data transfer with a control unit of a motor vehicle;
b) a diagnostic unit configured to perform a diagnosis of the motor vehicle based on the diagnostic data transferred from the control unit to the communication unit;
c) a transmitting unit configured to transfer diagnostic data of the diagnostic module from the diagnostic module to a server via at least one of a mobile radio network and the internet, wherein the diagnostic unit is further configured to read out first data from the control unit into the diagnostic module, and the transmitting unit is further configured to transfer the first data from the diagnostic module to the server; and
d) a diagnostic module receiving unit configured to receive, after transfer of the first data to the server, a diagnostic software program transferred from the server to the diagnostic module, wherein the diagnostic unit is configured to carry out the diagnosis of the motor vehicle on the basis of the transferred diagnostic data, using the received diagnostic software.

14. The diagnostic module as recited in claim 13, wherein the diagnostic module receiving unit is configured to receive data from the server.

15. The diagnostic module as recited in claim 14, wherein the diagnostic module is configured to be selectably connected to the control unit of a motor vehicle via a plug connection.

16. The diagnostic module as recited in claim 14, wherein the diagnostic module is configured to be selectably connected to the control unit of a motor vehicle via a wherein the diagnostic module is configured to be selectably connected to the control unit of a motor vehicle via a radio connection.

17. The diagnostic module as recited in claim 14, further comprising:
a location determination module configured to determine the current position of the motor vehicle;
wherein the transmitting unit is configured to transfer to the server, in addition to the diagnostic data received from the control unit, position data describing the current position of the motor vehicle.

18. A system for vehicle diagnosis, comprising:
a) at least one diagnostic module for vehicle diagnosis, the at least one diagnostic module including:
i) a communication unit configured for data transfer with a control unit of a motor vehicle;
ii) a diagnostic unit configured to perform a diagnosis of the motor vehicle based on the diagnostic data transferred from the control unit to the communication unit;
iii) a transmitting unit configured to transfer diagnostic data of the diagnostic module from the diagnostic module to a server via at least one of a mobile radio network and the internet, wherein the diagnostic unit is further configured to read out first data from the control unit into the diagnostic module, and the transmitting unit is further configured to transfer the first data from the diagnostic module to the server; and
iv) a diagnostic module receiving unit configured to receive, after transfer of the first data to the server, a diagnostic software program transferred from the server to the diagnostic module, wherein the diagnostic unit is configured to carry out the diagnosis of the motor vehicle on the basis of the transferred diagnostic data, using the received diagnostic software;
b) at least one server configured to make diagnostic data available for retrieval; and
c) a receiving station configured to receive diagnostic data from the diagnostic module and forward the received diagnostic data to the server.

19. The system as recited in claim 18, wherein the server is configured to anonymize the received data.

20. The system as recited in claim 18, wherein the server is configured to (i) receive position data from the diagnostic module, and (ii) on the basis of the received position data, at least one of (a) identify and display at least one service facility in the vicinity of the motor vehicle and (b) contact the at least one identified service facility.

21. The system as recited in claim 18, wherein the server includes at least one user data receiving apparatus, the server being configured to display, together with the diagnostic data, user data received by the user data receiving apparatus, and the user data receiving apparatus being configured to receive at least one of SMS messages and e-mails.

22. The system as recited in claim 18, further comprising:
a server transmitting apparatus configured to transfer data including a diagnostic software program from the server to the diagnostic module.

23. A method for vehicle diagnosis using a diagnostic module, the method comprising:
a) reading out diagnostic data from a control unit of a motor vehicle into the diagnostic module;
b) carrying out a diagnosis of the motor vehicle based on the diagnostic data read out from the control unit; and
c) transferring diagnostic data from the diagnostic module to a server via at least one of a mobile radio network and the internet, wherein the transferring includes:
i) reading out first data from the control unit into the diagnostic module and transferring them from the diagnostic module to the server;
ii) evaluating the first data in order to select a suitable diagnostic software program and transferring the selected diagnostic software program from the server to the diagnostic module; and
iii) carrying out a vehicle diagnosis on the basis of the transferred diagnostic data, using the received diagnostic software program.

24. The method as recited in claim 23, wherein at least one of (i) the diagnostic data and (ii) results of the vehicle diagnosis are transferred from the diagnostic module to the server.
